(19) United States
(12) Patent Application Publication
(10) Pub. No.: US 2014/0040200 A1
(43) Pub. Date: Feb. 6, 2014

(54) MEDIATION OBJECTS FOR COMPLEX REPLICATIONS

(71) Applicants: Matthias Richter, Sinsheim (DE); Thomas Moser, Wiesloch (DE); Fabian Guenther, Mauer (DE)

(72) Inventors: Matthias Richter, Sinsheim (DE); Thomas Moser, Wiesloch (DE); Fabian Guenther, Mauer (DE)

(73) Assignee: SAP AG, Walldorf (DE)

(21) Appl. No.: 13/566,390

(22) Filed: Aug. 3, 2012

(51) Int. Cl. G06F 17/30

(52) U.S. Cl. 707/634; 707/E17.005

(57) ABSTRACT

A method includes receiving, at a mediation object in a target system, one or more replication requests from a source system, where the replication requests include requests to replicate data on the target system from one or more source objects located at the source system. The mediation object collects and stores data from the source objects of the source system as part of the replication requests. The mediation object determines when data from the source objects of the source system are complete and processes completed data from the source objects of the source system by distributing the data to one or more target objects in the target system.

### TECHNICAL FIELD

This description relates to mediation objects for complex replications.

### BACKGROUND

Objects may be replicated from a source system to a target system in order to transfer data from the source system to the target system. Messages may be used to communicate the objects from the source system to the target system. There may be many reasons why the object replication may fail. For instance, the target system may reject the messages containing the objects because the objects from the source system include errors and/or incomplete data. In other instances, the target system may accept the messages containing the objects, but may not be able to process and replicate the objects because the objects include errors and/or incomplete data. Still, in other instances, the target system may accept the messages containing the objects, but may not be able to process and replicate the objects because the replication to the target objects may require processing in a special order and/or because of errors related to a combination of target objects needed for the replication. This may occur, for example, when data from “n” objects on the source system need to be mapped to “m” objects on the target system.

Consideration is now being given to systems and methods for object replication from a source system to a target system.

### SUMMARY

According to one general aspect, a method includes receiving, at a mediation object in a target system, one or more replication requests from a source system, where the replication requests include requests to replicate data on the target system from one or more source objects located at the source system. The mediation object collects and stores data from the source objects of the source system as part of the replication requests. The mediation object determines when data from the source objects of the source system are complete and processes completed data from the source objects of the source system by distributing the data to one or more target objects in the target system.

Implementations may include one or more of the following features. For example, the mediation object may be a single point of entry for replication requests made by the source system to the target system. The replication requests may include data from multiple source objects located at the source system and a number of the multiple source objects differs from a number of multiple target objects in the target system that receive the distributed data from the mediation object.

The method may include enabling error correction of collected and stored data from the source objects by a user through a user interface capable of displaying the data at the mediation object. The method may include correcting errors in the data received from the source objects, by the mediation object, prior to distributing the completed data to the target objects.

The method may include creating a new mediation object instance for each received replication request and collecting and storing, by each respective mediation object instance, data from the source objects associated with each received replication request, where processing the completed data includes combining data from a plurality of mediation object instances and distributing the combined data to one or more target objects. Processing the completed data may include creating new target objects and distributing the data to the new target objects in the target system. Processing the completed data may include processing the completed data in a batch mode and distributing the data to the target objects in parallel.

In another general aspect, a non-transitory computer-readable storage medium stores instructions that, when executed, cause one or more processors to perform the actions of receiving, at a mediation object in a target system, one or more replication requests from a source system, where the replication requests include requests to replicate data on the target system from one or more source objects located at the source system. The mediation object collects and stores data from the source objects of the source system as part of the replication requests. The mediation object determines when data from the source objects of the source system are complete and processes completed data from the source objects of the source system by distributing the data to one or more target objects in the target system.

Implementations may include one or more of the following features. For example, the mediation object may be a single point of entry for replication requests made by the source system to the target system. The replication requests may include data from multiple source objects located at the source system and a number of the multiple source objects differs from a number of multiple target objects in the target system that receive the distributed data from the mediation object.

The non-transitory computer-readable storage medium may further include instructions that, when executed, cause the one or more processors to perform the action of enabling error correction of collected and stored data from the source objects by a user through a user interface capable of displaying the data at the mediation object. The non-transitory computer-readable storage medium may further include instructions that, when executed, cause the one or more processors to perform the action of correcting errors in the data received from the source objects, by the mediation object, prior to distributing the completed data to the target objects.

The non-transitory computer-readable storage medium may further include instructions that, when executed, cause one or more processors to perform the actions of creating a new mediation object instance for each received replication request and collecting and storing, by each respective mediation object instance, data from the source objects associated with each received replication request, where processing the completed data includes combining data from a plurality of mediation object instances and distributing the combined data to one or more target objects. Processing the completed data may include creating new target objects and distributing the data to the new target objects in the target system. Processing the completed data may include processing the completed data in a batch mode and distributing the data to the target objects in parallel.

In another general aspect, a computer system includes a mediation object at a target system that is configured to receive, one or more replication requests from a source system, where the replication requests include requests to replicate data on the target system from one or more source objects located at the source system. The mediation object is configured to collect and store data from the source objects of the source system as part of the replication requests and determine when data from the source objects of the source system are complete. A mediation object processor is configured to process completed data from the source objects of the source system by distributing the data to one or more target objects in the target system.

Implementations may include one or more of the following features. For example, the mediation object may be a single point of entry for replication requests made by the source system to the target system. The replications requests may include data from multiple source objects located at the source system and a number of the multiple source objects may differ from a number of multiple target objects in the target system that receive the distributed data from the mediation object. The computer system may include a user interface capable of displaying the data at the mediation object to enable error correction of collected and stored data from the source objects by a user.

The details of one or more implementations are set forth in the accompanying drawings and the description below. Other features will be apparent from the description and drawings, and from the claims.

### BRIEF DESCRIPTION OF THE DRAWINGS

FIG. 1 is an exemplary block diagram of a source system and a target system including a mediation object.

FIG. 2 is an exemplary flowchart illustrating example operations of the system of FIG. 1.

FIG. 3 is an exemplary block diagram illustrating an example source system and an example target system including a mediation object.

### DETAILED DESCRIPTION

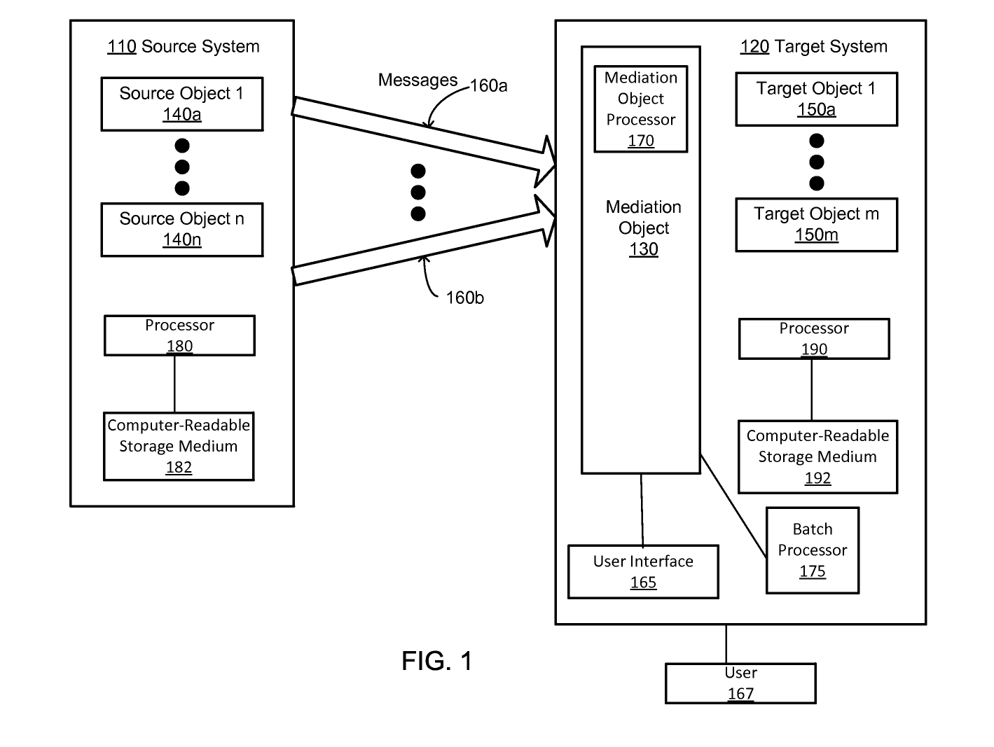

FIG. 1 is an exemplary block diagram for the replication of objects from a source system 110 to a target system 120 using a mediation object 130 on the target system 120. The mediation object 130 may be implemented on the target system 120 and may receive replication requests from the source system 110 to replicate data on the target system 120 from one or more source objects 140a-140n located on the source system 110. The data from the source objects 140a-140n may be replicated in newly created and/or existing target objects 150a-150m on the target system 120.

The mediation object 130 may be a single point of entry on the target system 120 for replication requests received from the source system 110. In this manner, all replication requests received at the target system 120 from the source system 110 or any other system (not shown) may be processed through the mediation object 130.

The replication requests may be communicated from the source system 110 to the target system 120 using one or more messages 160a-160n. The messages 160a-160n may communicated from the source system 110 to the target system 120 using a network (not shown). The network may include a wired and/or a wireless network including, for example, a local area network (LAN) or a wide area network (WAN). One example of a WAN may include the Internet.

The mediation object 130 may function to collect data from the source objects 140a-140n and to store the data until the data is determined to be complete by the mediation object 130. The mediation object 130 may receive, collect and store the information from the source objects 140a-140n without rejecting the data and/or the messages 160a-160n used to communicate the data, even if the data contains errors and/or is incomplete. In this manner, the mediation object 130 may accept all messages 160a-160n received from the source system 110.

The mediation object 130 is configured with information regarding the target objects 150a-150m on the target system 120. The mediation object 130 is aware of the data requirements for each target object that may be instantiated on the target system 120. In this manner, the mediation object 130 may collect and hold the incoming replication requests until the mediation object 130 knows that the data is complete and/or error free prior to distributing the data to one or more of the target objects 150a-150m.

The mediation object 130 is configured to distribute the data being replicated to one or more of the target objects 150a-150m. The mediation object 130 may distribute the data to existing target objects 150a-150m or it may create one or more new target objects in order to distribute the data. The mediation object 130 is configured to process and distribute the data to the target objects 150a-150m in the correct order, as may be required by the particular target objects. In this manner, the mediation object 130 may collect and store the incoming data from the source objects 140a-140n until the mediation object 130 determines that the data is complete and can be distributed to the target objects 150a-150n in the correct order.

The mediation object 130 is configured to know and determine which target objects 150a-150m should receive the completed data. In this manner, the source system 110 does not need to know which information goes to which target objects and does not need to be concerned with the order in which the data is sent to the target system 120.

The mediation object 130 is configured to handle complex replication requests. For example, the mediation object 130 may process replication requests where there are 1 through n source objects that get replicated to 1 through m target objects. In this manner, the source system 110 may send replication requests from “x” number of source objects and the mediation object 130 may distribute the data to “y” number of target objects. Also, the mediation object 130 may process replication requests of differently tailored object types.

The mediation object 130 is configured to handle errors and process error corrections on the data received from the source objects 140a-140n. Prior to distributing data to the target objects, the mediation object 130 allows for error correction. The target system 120 includes a user interface 165 that interfaces with the mediation object 130. The user interface 165 allows a user 167 to view information related to the replicated data, including error-related information, at the mediation object 130 before it is replicated and distributed to the target objects 150a-150m. The mediation object 130 through the user interface 165 may show the central status of errors and of data completeness. That is, the user interface 165 may show the status and readiness state from processing the collected data. The user interface 165 may provide a window to view the replication requests, while hiding the complexity of the object types in the target system 120.

In one exemplary implementation, the existing target objects in the target system 120 may still be used while new object data is being collected, stored and potentially corrected at the mediation object 130. Once all of the required data from the source objects are present and/or corrected at the mediation object 130, then the new data can be replicated and replace the data, as appropriate, in the target objects. The mediation object 130 is aware of the requirements to create or update a complete object on the target system 120. The mediation object 130 may process data that is complete from the perspective of the target objects 150a-150m.

In one exemplary implementation, the mediation object 130 may process the received replication requests in an “insert only” mode. That is, every replication request is taken into the mediation object 130 as an insert. This means that the mediation object 130 itself may represent a replication request. A view of the mediation object 130 through the user interface 165 means looking at the replication request. A mediation object 130 of this kind has the semantics of a replication request for some “virtual object.” In this manner, no complicated update mechanism are used. The replicated data may be inserted in a manner faster than using an update mechanism.

As discussed above, the mediation object 130 will accept all or almost all data from the source system 110. In this manner, the source system 110 may send data from one object in a first step, where the data from the first step is regarded as incomplete in the target system 120, and the mediation object 130 will not reject the data. The source system 110 can send additional data in a second step, where the additional data completes the data sent in the first step and the mediation object 130 will match the data from both steps and distribute it to one or more target objects 150a-150m, as may be appropriate.

In one implementation, the mediation object 130 may attempt to process the collected and stored data, when the data is determined to be complete. The mediation object 130 may include a mediation object processor 170, where the mediation object processor 170 may be used to process the completed data. Processing the data includes distributing the data to one or more target objects 150a-150m. During the processing, the target objects 150a-150m may signal one or more errors. For instance, the errors may arise from incorrect and/or missing data. The errors may be persisted in the mediation object 130 and the processing may be regarded as not successful. The errors may be corrected directly in the mediation object 130, including by a user 167 through the user interface 165. Once the errors are corrected, the mediation object processor 170 may attempt again to process the data. This process may repeat until the data is successfully processed.

In one exemplary implementation, the mediation object 130 may process the completed data in a batch mode. The target system 120 may include a batch processor 175 that is operably coupled to the mediation object 130. The batch processor 175 may be configured to process the completed data on a periodic basis. For example, the batch processor 175 may be scheduled to process the completed data from the mediation object 130 once a day, twice a day, or on some other periodic basis. The data may be packaged into groups of optimal package sizes and then may be distributed to the target objects 150a-150m in parallel sessions. In this instance, every session may be handling multiple packages in parallel with other sessions until the processing is complete.

In one exemplary implementation, for processing smaller amount of data and for manual tests, the data may be processed directly at the mediation object 130 using the mediation object processor 170.

In one exemplary implementation, the mediation object 130 processes the data in the correct order with respect to the point in time when they are sent by the source system 110. A later change of specific data overwrites earlier changes.

As discussed above, the mediation object 130 also determines a correct sequence when it processes the data, i.e., when the mediation object 130 distributes the data to the target objects. For example, the mediation object 130 may first create a target object and then create a second target object that is dependent on the first target object in order to process the data properly. This ensures that the source system 110 does not need to know about the details of the dependencies in the design of the target system 120.

In one exemplary implementation, if target objects are dependent on each other, the mediation object 130 may process the data using a multi-step approach. For instance, the mediation object 130 may first create a target object in a non-dependent state without any reference to a second target object. Then, the mediation object 130 may create a second target object, which is dependent on the first target object. Next, the mediation object 130 may modify the first target object by referencing the first target object to the second target object. Other multi-step target object create processes also are possible. The mediation object can account for target system configuration settings and/or system scope to determine whether and which target objects have to be created and/or updated.

As shown, and as would be appreciated, the source system 110 and the target system 120 each may be at least one computing device and include or utilize at least one processor 180 and 190, respectively, as well as at least one computer-readable storage medium 182 and 192, respectively. Of course, the at least one processor 180 and 190 and the computer-readable storage medium 182 and 192 may be understood to represent or include any known or future examples of corresponding components that may be utilized in the context of the source system 110 and the target system 120. Further, it may be appreciated that any additional, or otherwise conventional, components may be utilized in the context of the source system 110 and the target system 120, including, for example, components related to power, communications, input/output functions, and many other conventional features and functions that would be understood by one of skill in the art to be potentially implemented in the context of the source system 110 and the target system 120.

Moreover, although the source system 110 and the target system 120 are illustrated in the example of FIG. 1 as a single computing device, it may be understood that the source system 110 and the target system 120 may represent two or more computers in communication with one another. It may be appreciated that any two components illustrated in the example of FIG. 1 may be executed together as a single component. Conversely, any single component of FIG. 1 may be understood to be executed using two or more subcomponents.

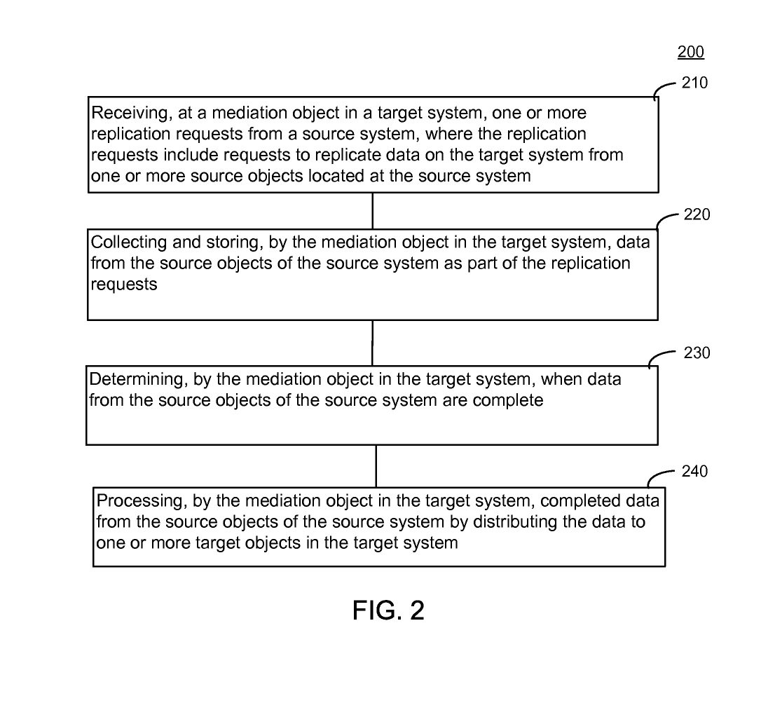

Referring to FIG. 2, an exemplary flowchart illustrates an example process 200, which illustrates example operations of the systems of FIG. 1. Process 200 includes receiving, at a mediation object in a target system, one or more replication requests from a source system, where the replication requests includes requests to replicate data on the target system from one or more source objects located at the source system (210). For example, in the context of FIG. 1, the mediation object 130 may receive, at a target system 120, one or more replication requests from a source system 110 (210). The mediation object 130 represents the single point of entry for replication in the target system 120. The replication requests include requests to replicate data on the target system 120 from one or more source objects 140a-140n located at the source system 110.

Process 200 includes collecting and storing, by the mediation object in the target system, data from the source objects of the source system as part of the replication requests (220). In the context of FIG. 1, the mediation object 130 collects and stores data from the source objects 140a-140n of the source system 110 as part of the replication requests (220).

Process 200 includes determining, by the mediation object in the target system, when data from the source system are complete (230). In the context of FIG. 1, the mediation object 130 determines when data from the source system 110 are complete (230). As discussed above, the mediation object 130 knows the requirements for replicating the received data as target objects on the target system and can determine when the received data are complete to process and distribute the data.

Process 200 also includes processing, by the mediation object in the target system, completed data from the source objects of the source system by distributing the data to one or more target objects in the target system (240). In the context of FIG. 1, the mediation object 130 processes the completed data from the source objects 140a-140n by distributing the data to one or more target objects 150a-150m in the target system 120 (240). In this manner, the mediation object 130 is able to receive and process complex replication requests to include requests where “n” objects of a source system 110 correspond to “m” objects in a target system 120.

The mediation object 130 enables a user 167 of the target system 120 to view the incoming replication requests and their processing state through a user interface 165. For example, in the case of processing errors, all information regarding the error may be viewed by the user 167 at the central collection point of the mediation object 130. Error correction and reprocessing may be performed directly on the data in the mediation object 130, which immediately provides feedback to the user 167 if the correction solves the issue.

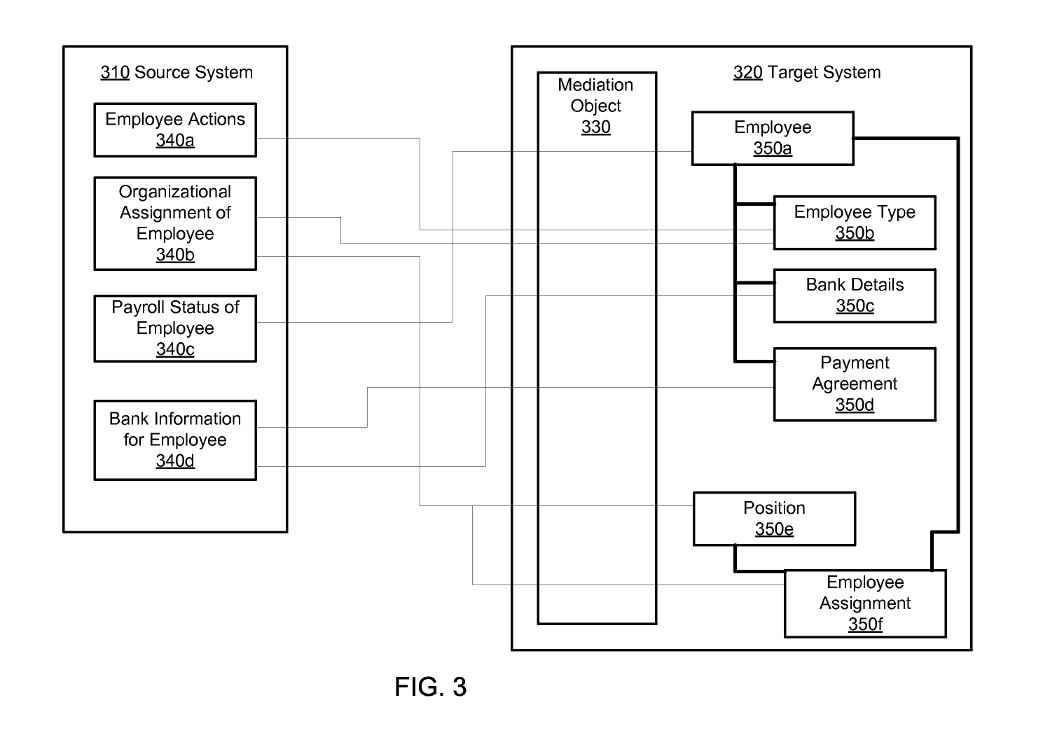

Referring to FIG. 3, an exemplary block diagram illustrates an example source system 310 and an example target system 320 including a mediation object 330. In this example, the source system 310 includes four (4) source objects 340a-340d having data that are to be replicated on the target system 320. In this example, the source objects 340a-340d are replicated as six (6) target objects 350a-350f on the target system 320 by the mediation object 330. For instance, the source system 310 may represent one system that stores employee data in one manner using four objects and the target system may represent a different system that stores employee data in a different manner using six objects.

The mediation object 330 receives the replication requests from the source system 310. The mediation object 330 collects and stores the data from the source objects 340a-340d until such time that the mediation object 330 determines that the received data are complete and can be processed for distribution to the target objects 350a-350f.

As can be seen from this example, the target objects 350a-350f may have dependencies from multiple source objects. For example, the target object 350b requires data from both source objects 340a and 340b in order to be created. Also, target object 350a is dependent, in part, on target object 350b. However, the source system 310 does not need to know of the dependencies or the sequence of the creation of the target objects 350a-350f. As discussed above, the mediation object 330 handles the dependencies and the sequencing so that the source system 310 doesn't need to be concerned with that information. In this manner, the source system 310 can simply communicate the source objects to the target system 320 and the mediation object 330 will collect, store and distribute the data to the target objects 350a-350f in the proper sequence taking into account the dependencies between the target objects 350a-350f.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a non-transitory machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method including executing instructions recorded on a non-transitory computer-readable storage medium using at least one processor, the method comprising:
receiving, at a mediation object in a target system, one or more replication requests from a source system, wherein the replication requests include requests to replicate data on the target system from one or more source objects located at the source system;
collecting and storing, by the mediation object in the target system, data from the source objects of the source system as part of the replication requests;
determining, by the mediation object in the target system, when data from the source objects of the source system are complete; and
processing, by the mediation object in the target system, completed data from the source objects of the source system by distributing the data to one or more target objects in the target system.

2. The method as in claim 1 wherein the mediation object is a single point of entry for replication requests made by the source system to the target system.

3. The method as in claim 1 wherein the replication requests include data from a plurality of source objects located at the source system and wherein a number of the plurality of source objects differs from a number of a plurality target objects in the target system that receive the distributed data from the mediation object.

4. The method as in claim 1 further comprising enabling error correction of collected and stored data from the source objects by a user through a user interface capable of displaying the data at the mediation object.

5. The method as in claim 1 further comprising correcting errors in the data received from the source objects, by the mediation object, prior to distributing the completed data to the target objects.

6. The method as in claim 1 further comprising:
creating a new mediation object instance for each received replication request; and
collecting and storing, by each respective mediation object instance, data from the source objects associated with each received replication request, wherein processing the completed data comprises combining data from a plurality of mediation object instances and distributing the combined data to one or more target objects.

7. The method as in claim 1 wherein processing the completed data comprises creating new target objects and distributing the data to the new target objects in the target system.

8. The method as in claim 1 wherein processing the completed data comprises processing the completed data in a batch mode and distributing the data to the target objects in parallel.

9. A non-transitory computer-readable storage medium storing instructions that, when executed, cause one or more processors to perform the actions of:
receiving, at a mediation object in a target system, one or more replication requests from a source system, wherein the replication requests include requests to replicate data on the target system from one or more source objects located at the source system;
collecting and storing, by the mediation object in the target system, data from the source objects of the source system as part of the replication requests;
determining, by the mediation object in the target system, when data from the source objects of the source system are complete; and
processing, by the mediation object in the target system, completed data from the source objects of the source system by distributing the data to one or more target objects in the target system.

10. The non-transitory computer-readable storage medium of claim 9 wherein the mediation object is a single point of entry for replication requests made by the source system to the target system.

11. The non-transitory computer-readable storage medium of claim 9 wherein the replication requests include data from a plurality of source objects located at the source system and wherein a number of the plurality of source objects differs from a number of a plurality target objects in the target system that receive the distributed data from the mediation object.

12. The non-transitory computer-readable storage medium of claim 9 further comprising instructions that, when executed, cause the one or more processors to perform the action of enabling error correction of collected and stored data from the source objects by a user through a user interface capable of displaying the data at the mediation object.

13. The non-transitory computer-readable storage medium of claim 9 further comprising instructions that, when executed, cause the one or more processors to perform the action of correcting errors in the data received from the source objects, by the mediation object, prior to distributing the completed data to the target objects.

14. The non-transitory computer-readable storage medium of claim 9 further comprising instructions that, when executed, cause one or more processors to perform the actions of:
creating a new mediation object instance for each received replication request; and
collecting and storing, by each respective mediation object instance, data from the source objects associated with each received replication request, wherein processing the completed data comprises combining data from a plurality of mediation object instances and distributing the combined data to one or more target objects.

15. The non-transitory computer-readable storage medium of claim 9 wherein processing the completed data comprises creating new target objects and distributing the data to the new target objects in the target system.

16. The non-transitory computer-readable storage medium of claim 9 wherein processing the completed data comprises processing the completed data in a batch mode and distributing the data to the target objects in parallel.

17. A computer system comprising:
a mediation object at a target system that is configured to:
receive, one or more replication requests from a source system, wherein the replication requests include requests to replicate data on the target system from one or more source objects located at the source system,
collect and store data from the source objects of the source system as part of the replication requests, and
determine when data from the source objects of the source system are complete; and
a mediation object processor that is configured to process completed data from the source objects of the source system by distributing the data to one or more target objects in the target system.

18. The computer system claim 17 wherein the mediation object is a single point of entry for replication requests made by the source system to the target system.

19. The computer system of claim 17 wherein the replications requests include data from a plurality of source objects located at the source system, wherein a number of the plurality of source objects differs from a number of a plurality target objects in the target system that receive the distributed data from the mediation object.

20. The computer system of claim 17 further comprising a user interface capable of displaying the data at the mediation object to enable error correction of collected and stored data from the source objects by a user.
